(19) United States
(12) Patent Application Publication
(10) Pub. No.: US 2004/0246902 A1
(43) Pub. Date: Dec. 9, 2004

(54) Systems and methods for synchronizing multple copies of a database using datablase digest

(76) Inventors: Joseph J. Weinstein, Somerville, MA (US); Vladimir Rosenzweig, Belmont, MA (US); Joseph Keller, Ledyard, CT (US); Jonathan Shapiro, Framingham, MA (US); David S. Pearson, Bennington, VT (US)

Correspondence Address: ROPES & GRAY LLP, ONE INTERNATIONAL PLACE, BOSTON, MA, 02110-2624, US

(21) Appl. No.: 10/797,030

(22) Filed: Mar. 11, 2004

Related U.S. Application Data
(60) Provisional application No. 60/475,177, filed on Jun. 2, 2003.
(60) Provisional application No. 60/493,660, filed on Aug. 8, 2003.
(60) Provisional application No. 60/550,316, filed on Mar. 8, 2004.

(51) Int. Cl. H04L 12/26; G06F 11/00; H04J 1/16; H04J 3/14

(52) U.S. Cl. 370/238

(57) ABSTRACT

A system uses database digests to synchronize routing data in a network (100). The system includes a first node (110-1) and a second node (110-2). The first node (110-1) stores first routing data and the second node (110-2) stores second routing data. The second node (110-2) further performs a function on a portion of the second routing data, where the function produces a database digest that has substantially less data than the portion of the second routing data. The second node (110-2) also sends the database digest to the first node (110-1) to synchronize the second routing data with the first routing data.

### CROSS REFERENCE TO RELATED APPLICATIONS

The instant application claims priority from provisional application No. 60/475,177 (Attorney Docket No. 03-4001PRO2), filed Jun. 2, 2003; provisional application No. 60/493,660 (Attorney Docket No. 03-4001PRO3), filed Aug. 8, 2003; and provisional application No. ______ (Attorney Docket No. 03-4001PRO4), filed Mar. 8, 2004; the disclosures of which are hereby incorporated herein by reference in their entireties.

### RELATED APPLICATION

The present application is related to commonly assigned U.S. patent application Ser. No. 09/546,052 (Attorney Docket No. 99-432), entitled “Radio Network Routing Apparatus,” and filed Apr. 10, 2000, the disclosure of which is hereby incorporated herein by reference in its entirety.

The instant application is related to commonly assigned co-pending U.S. application Ser. No. ______ (Attorney Docket No. 014087), entitled “Method and System for Synchronizing Multiple Copies of a Database” and filed on ______, the disclosure of which is incorporated by reference herein in its entirety.

### GOVERNMENT CONTRACT

This invention was made with U.S. Government support under Contract No. DAAB-07-02-C-C403 awarded by the United States Army. The Government has certain rights in this invention.

### FIELD OF THE INVENTION

Systems and methods consistent with the principles of the invention relate generally to database communications networks and, more particularly, to Mobile Ad-Hoc Networks (MANETs) and to systems and methods for synchronizing routing databases between nodes in such networks.

### BACKGROUND OF THE INVENTION

Existing wired communications networks, such as, for example, the Internet, use various algorithms for disseminating routing data necessary for routing packets from a source node to a destination node. Each node of the network that handles packets has sufficient knowledge of the network topology such that it can choose the right output interface through which to forward received packets. Link state routing algorithms, such as the Open Shortest Path First (OSPF) algorithm, permit the construction of a network topology such that any given node in the network may make packet-forwarding decisions. OSPF is defined by Internet RFC 2328, STD 54, and related documents, published by the Internet Society. OSPF is also defined by Internet RFC 2740, and related documents, also published by the Internet Society.

Existing OSPF mechanisms for forming adjacencies between nodes in a network require the exchange of “database description” records to ensure synchronization of routing databases between neighboring routers. The “database description” records sent by each neighboring router lists every entry in its routing database, along with each entry's age and sequence number. The recipient of a “database description” record compares it to its own database contents, and generates requests for those entries that it lacks, or for those entries which are out of date. The original sender then marks those entries for flooding to the new neighbor using existing flooding mechanisms. Similar database synchronization algorithms are commonly employed by other link-state routing protocols, such as the well-known strategy of exchanging the entire routing database between newly-adjacent neighbors each time an adjacency forms.

Though this standard OSPF database synchronization process may be appropriate for wired point-to-point or multi-access (Ethernet like) networks, it may be too “expensive” for multi-hop, multi-access packet radio network (a Mobile, Ad-Hoc Network or MANET) in which adjacencies may be constantly breaking and reforming in ways that do not directly affect the contents of the OSPF routing database. Particularly, when the OSPF topology database is large and consists largely of unchanging routes “outside” of the radio network itself, mobility induced adjacency formation may become a major source of protocol overhead. Other commonly-used mechanisms for synchronizing routing databases suffer similar inefficiencies.

Therefore, there exists a need for systems and methods that can optimize the synchronization of routing databases during adjacency formation, and thereby resolve some of the inherent problems that exist with implementing OSPF and/or other link-state routing algorithms in a multi-hop, multi-access packet radio network.

### SUMMARY OF THE INVENTION

Systems and methods consistent with the present invention address this need, and others, by employing a database digest strategy in which routing database entries may be broken down into compartments, and a database digest, that may include a hash or checksum, may be computed over each of the compartments. The characteristic feature of a database digest is that it is much smaller than the data it describes, and yet permits a statistically reliable test for equality of that data. Equality of the database digest computed over two different sets of data provides a high degree of statistical certainty that the underlying data sets are also identical, while non-equality of the database digest is absolute proof for the non-identity of the underlying databases. Each of the database digests may be sent to the adjacent node, with which the routing database is being synchronized, and the adjacent node may compare the database digests with locally computed database digests of that node's own database to determine whether the contents of the corresponding compartments are identical, and hence in synchronization. An iterative search strategy may then be employed to identify rapidly those routing database entries which are out of synchronization. Each compartment, for which the digests do not match, may be further subdivided into sub-compartments, and digests of the sub-compartments may further be compared between the nodes. The iterative process may continue until each of the sub-compartments, that continue to have non-matching digests, is subdivided until a point at which it cannot be further subdivided (i.e., subdivided down to an individual route advertisement) or at which further subdivision is no longer useful (i.e., the contents of the subcompartment are not significantly larger than the database digest). Each of the individual route advertisements identified by this iterative search strategy may then be flooded between the synchronizing nodes to permit synchronization of the node's databases.

According to one aspect consistent with the principles of the invention, a method of synchronizing routing data with another node in a network is provided. The method may include receiving routing data and performing a function on at least a portion of the routing data to produce a first digest, where the first digest comprises substantially less data than the routing data. The method may further include receiving a second digest from the other node and comparing the first and second digests to determine whether they are identical to produce first comparison results. The method may also include exchanging a portion of the routing data based on the first comparison results.

According to another aspect consistent with principles of the invention, a method for designating nodes as one of a master node or a slave node for synchronizing routing data in a network is provided. The method may include subdividing routing data stored at a first node into multiple portions and counting the number of multiple portions to produce a first count. The method may further include receiving a first message from a second node at the first node, the first message comprising a second count associated with a number of subdivided portions of the second node's routing data, and comparing the first count with the second count to produce first comparison results. The method may also include designating the second node as a slave node based on the first comparison results and sending a second message to the second node if the second node is designated as a slave node, where the second message comprises a digest associated with the routing data stored at the first node.

According to a further aspect consistent with the principles of the invention, a method of using database digests to synchronize routing data between a first node and a second node in a network is provided. The method may include storing first routing data at the first node and storing second routing data at the second node. The method may further include performing, at the first node, a function on a portion of the first routing data, where the function produces a data digest that has substantially less data than the portion of the first routing data. The method may also include sending the database digest to the second node to synchronize the first routing data with the second routing data.

### BRIEF DESCRIPTION OF THE DRAWINGS

The accompanying drawings, which are incorporated in and constitute a part of this specification, illustrate exemplary embodiments of the invention and, together with the description, explain the invention. In the drawings,

FIG. 1 illustrates an exemplary network in which systems and methods, consistent with principles of the invention, may be implemented for distributing a routing database;

FIG. 2 illustrates an exemplary router configuration consistent with principles of the invention;

FIG. 3 illustrates an exemplary database consistent with principles of the invention;

FIG. 4 illustrates an exemplary database digest message consistent with principles of the invention;

FIG. 5 illustrates an exemplary database digest acknowledgment message consistent with principles of the invention;

FIGS. 6A and 6B depict an illustrative messaging sequence for synchronizing databases between nodes in the network of FIG. 1; and

FIGS. 7-12 are flow charts that illustrate an exemplary process, consistent with principles of the invention, for synchronizing databases between nodes in the network of FIG. 1.

### DETAILED DESCRIPTION

The following detailed description of the invention refers to the accompanying drawings. The same reference numbers in different drawings may identify the same or similar elements. Also, the following detailed description does not limit the invention. Instead, the scope of the invention is defined by the appended claims and their equivalents.

Systems and methods, consistent with principles of the invention, implement a database synchronization process that uses database “digests” for comparing the respective contents of routing databases stored at nodes in a network. Such “digests” may include, for example, a hash or a checksum computed over portions of the databases. The “digests” may be exchanged between the nodes in the network to permit comparisons of the digests computed at each node. The results of the comparisons may be used to determine specific data (e.g., route advertisements) within each of the databases that are “out of sync,” and which, therefore, may be exchanged between the nodes to ensure that each node has an identical copy of the data.

### EXEMPLARY NETWORK

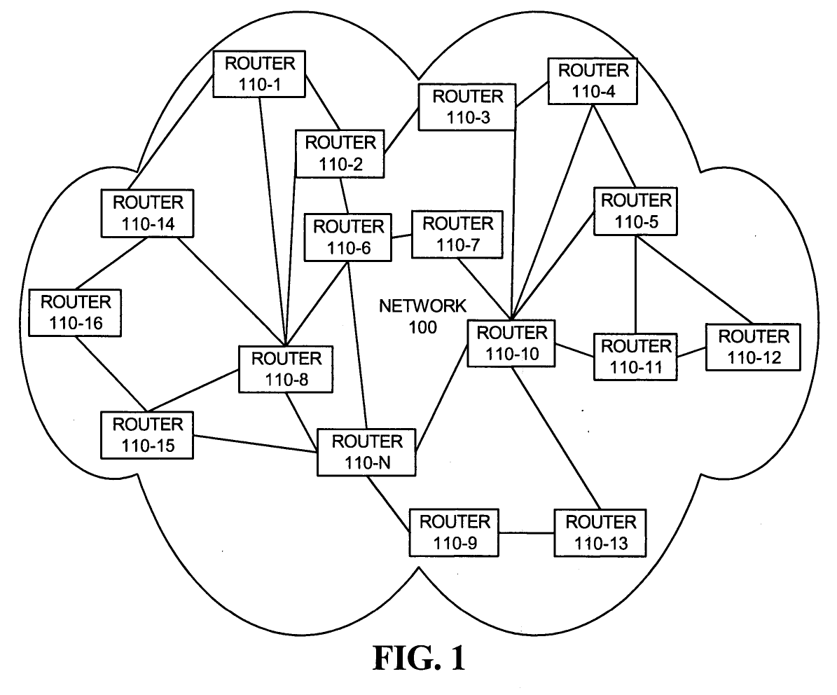

FIG. 1 illustrates an exemplary network 100 in which systems and methods, consistent with principles of the invention, may synchronize databases associated with respective nodes in network 100. Network 100 may include one or more networks of any type, including a local area network (LAN), a metropolitan area network (MAN), a wide area network (WAN), a multi-hop, multi-access packet-switched radio network, or a lower-layer Internet (IP) network such as used by IP over IP, VPN (Virtual Private Networks), or IPSec (IP Security). Network 100 may connect with other networks (not shown) that may include Ipv4 or Ipv6 networks.

Network 100 may include multiple routers 110-1 through 110-N for routing data through network 100. Routers 110-1 through 110-N may be interconnected via various links. Routers 110-1 through 110-N may be stationary, semi-stationary, or mobile network nodes. One or more hosts (not shown) may connect with network 100.

It will be appreciated that the number of routers illustrated in FIG. 1 is provided for explanatory purposes only. A typical network may include more or fewer routers than are illustrated in FIG. 1. Additionally, the various links between the routers of network 100 are shown by way of example only. More, fewer, or entirely different links may connect the various routers of network 100.

### EXEMPLARY ROUTER CONFIGURATION

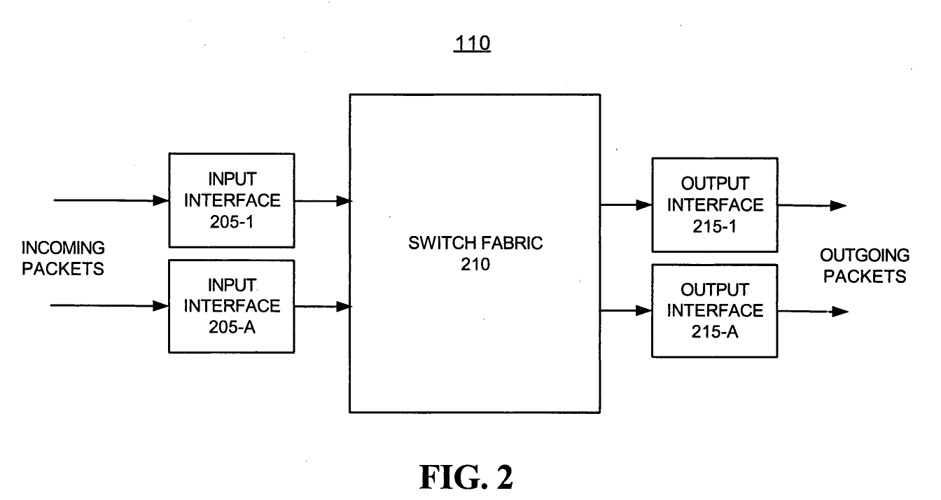

FIG. 2 illustrates exemplary components of a router 110 consistent with the present invention. In general, each router 110 receives incoming packets, determines the next destination (the next “hop” in network 100) for the packets, and outputs the packets as outbound packets on links that lead to the next destination. In this manner, packets “hop” from router to router in network 100 until reaching their final destination.

As illustrated, router 110 may include multiple input interfaces 205-1 through 205-A, a switch fabric 210, and multiple output interfaces 215-1-215-B. Each input interface 205 of router 110 may further include routing tables and forwarding tables (not shown). Through the routing tables, each input interface 205 may consolidate routing information learned from the routing protocols of the network. From this routing information, the routing protocol process may determine the active route to network destinations, and install these routes in the forwarding tables. Each input interface 205 may consult a respective forwarding table when determining a next destination for incoming packets.

In response to consulting a respective forwarding table, each input interface 205 may either set up switch fabric 210 to deliver a packet to its appropriate output interface 215, or attach information to the packet (e.g., output interface number) to allow switch fabric 210 to deliver the packet to the appropriate output interface 215. Each output interface 215 may queue packets received from switch fabric 210 and transmit the packets on to a “next hop.”

### EXEMPLARY DATABASE

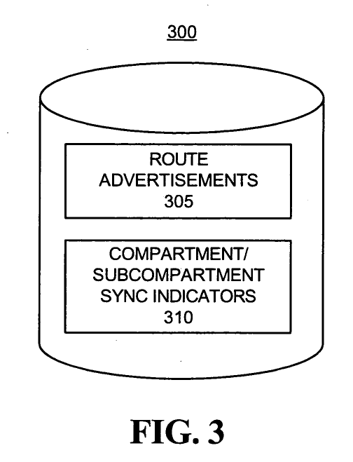

FIG. 3 illustrates an exemplary database 300 that may store route advertisements and database synchronization indicators. Database 300 may be stored in a memory associated with a router 110, or stored external to router 110. Database 300 may include route advertisements 305 and compartment/subcompartment synchronization (sync) indicators 310. Route advertisements 305 may include a copy of every route advertisement received from other routers 110 in network 100. Sync indicators 310 may include “markers” or “flags” indicating whether each compartment or sub-compartment (as described below) of route advertisements 305 is in-sync, or out-of-sync, with a corresponding compartment or sub-compartment of a neighboring router 110.

### EXEMPLARY DATABASE DIGEST MESSAGE

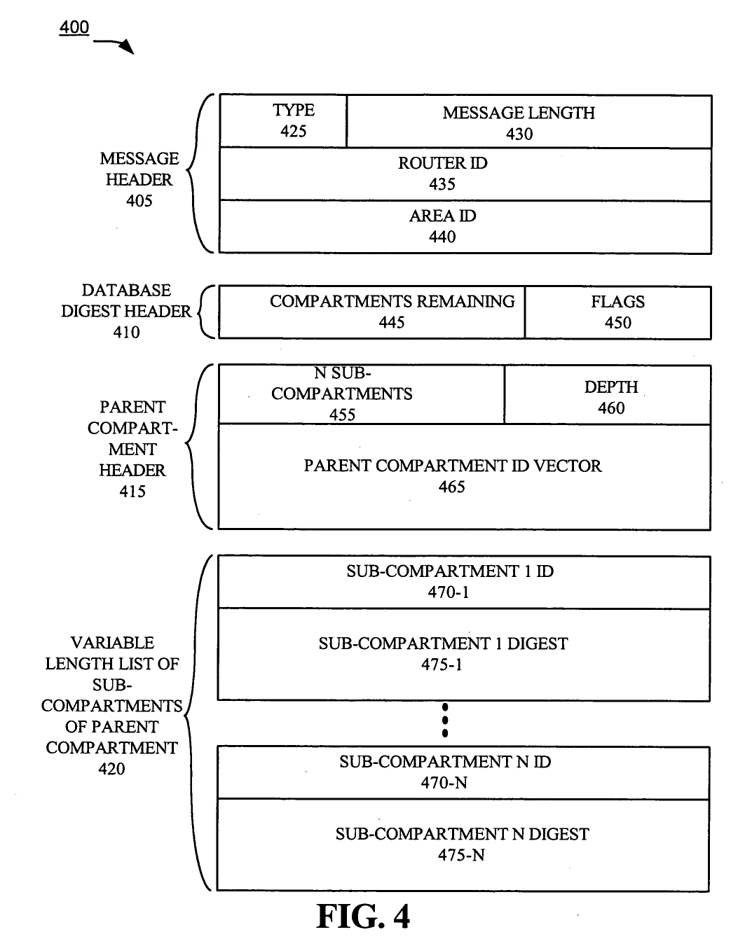

FIG. 4 illustrates an exemplary message 400 for sending one or more database digests between routers 110-1 through 110-N in network 100. Message 400 may include a message header 405, a database digest header 410, a parent compartment header 415, and a variable list 420 of sub-compartments of the parent compartment.

Message header 405 may include various fields, such as, for example, a message type field 425, a message length field 430, a router identification (ID) field 435, and an area ID field (440). Message header 405 may include other fields, not shown, such as those defined in RFC 2328 (e.g., checksum, authentication type, and authentication fields) and included in conventional OSPF messages. Message type field 425 may indicate that message 400 includes a database digest message. Message length field 430 may indicate a length of message 400 in any appropriate data size (e.g., bits, bytes, etc.). Router ID field 435 may identify the router 110 that sent message 400. Area ID field 440 may identify the OSPF area with which the router, identified by router ID field 435, may be associated.

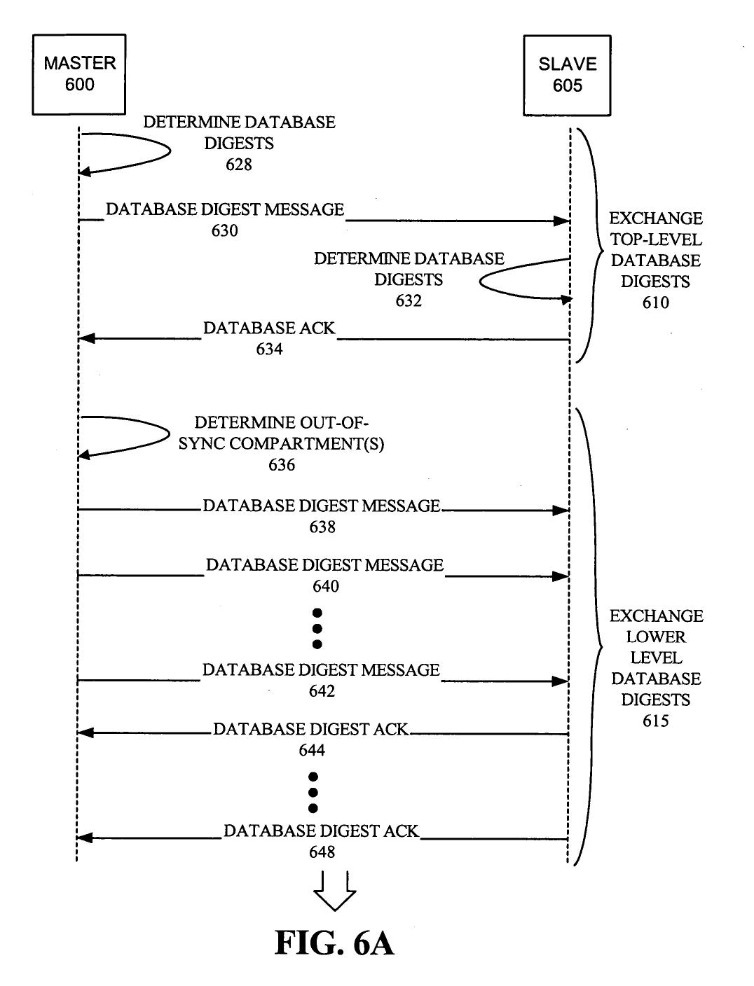

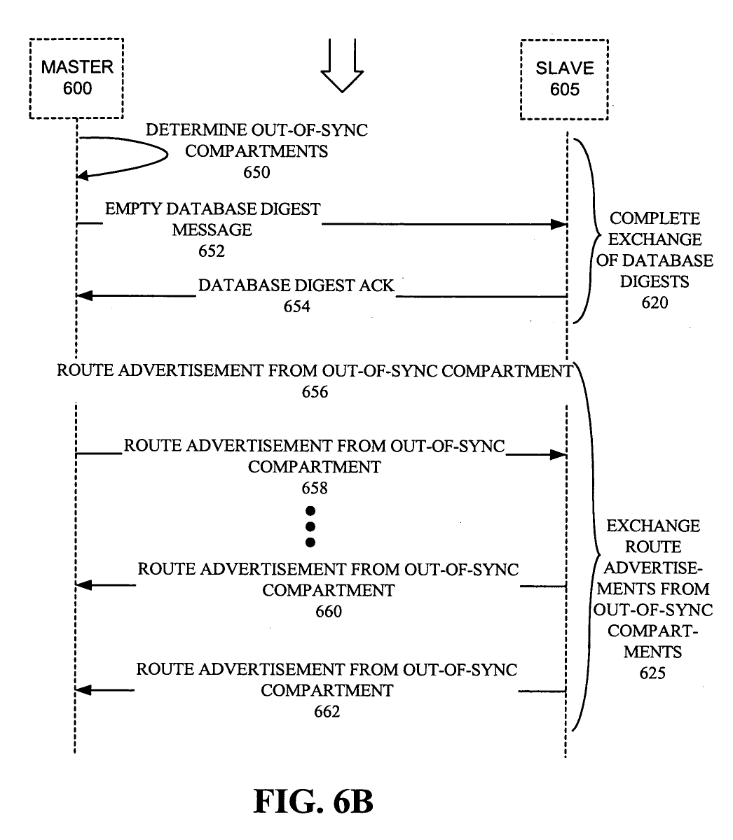

Database digest header 410 may include a “compartments remaining” field 445 and a “flags” field 450. “Compartments remaining” field 445 may indicate an estimate of a number of compartments (as described below with respect to FIGS. 6A and 6B) remaining to be exchanged. Field 445 may be used on a first exchange between two routers in network 100 to select an optimal “master” node for the database digest exchange. Flags field 450 may be used for synchronizing a start of the database digest exchange.

Parent compartment header 415 may include an N subcompartments field 455, a depth field 460, and a parent compartment ID vector 465. N subcompartments field 455 may indicate a number of non-empty subcompartments in the parent compartment. Depth field 460 may indicate a depth of the parent compartment in a compartment tree. Parent compartment ID vector 465 may include a vector of hash values identifying the parent compartment. ID vector 465 may be variable in length depending on the depth indicated by depth field 460.

Variable length list 420 of sub-compartments of the parent compartment may include one or more sub-compartment IDs 470-1 through 470-N and one or more sub-compartment digests 475-1 through 475-N. Each sub-compartment ID 470 may include, for example, a hash value distinguishing the sub-compartment from all other subcompartments of the parent compartment. Each sub-compartment digest 475 may include a database digest value for the sub-compartment.

### EXEMPLARY DATABASE DIGEST ACKNOWLEDGMENT MESSAGE

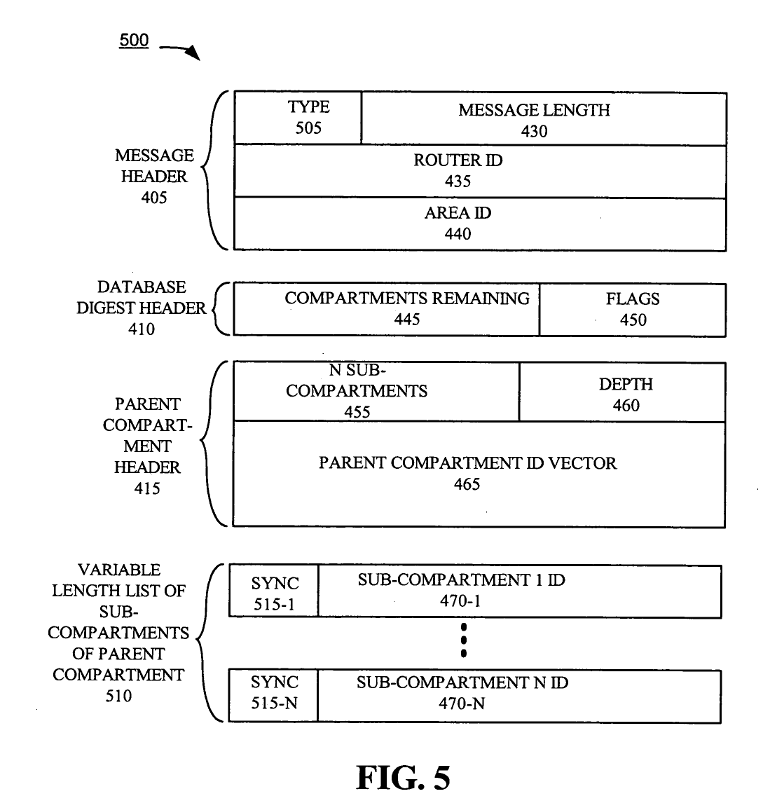

FIG. 5 illustrates an exemplary message 500 for responding to a previously received database digest message 400. Message 500 may include a similar message header 405, database digest header 410 and parent compartment header 415 described above with respect to message 400. Type field 505 in message header 405 may indicate that message 500 includes a database digest acknowledgment (ACK) message. Message 500 may further include a variable list 510 of sub-compartments of the parent compartment that may include synchronization (sync) values 515-1 through 515-N associated with each respective sub-compartment ID fields 470-1 through 470-N. Each sync value 515 may indicate whether the associated sub-compartment is synchronized, or not synchronized.

### EXEMPLARY DATABASE DIGEST MESSAGING SEQUENCE

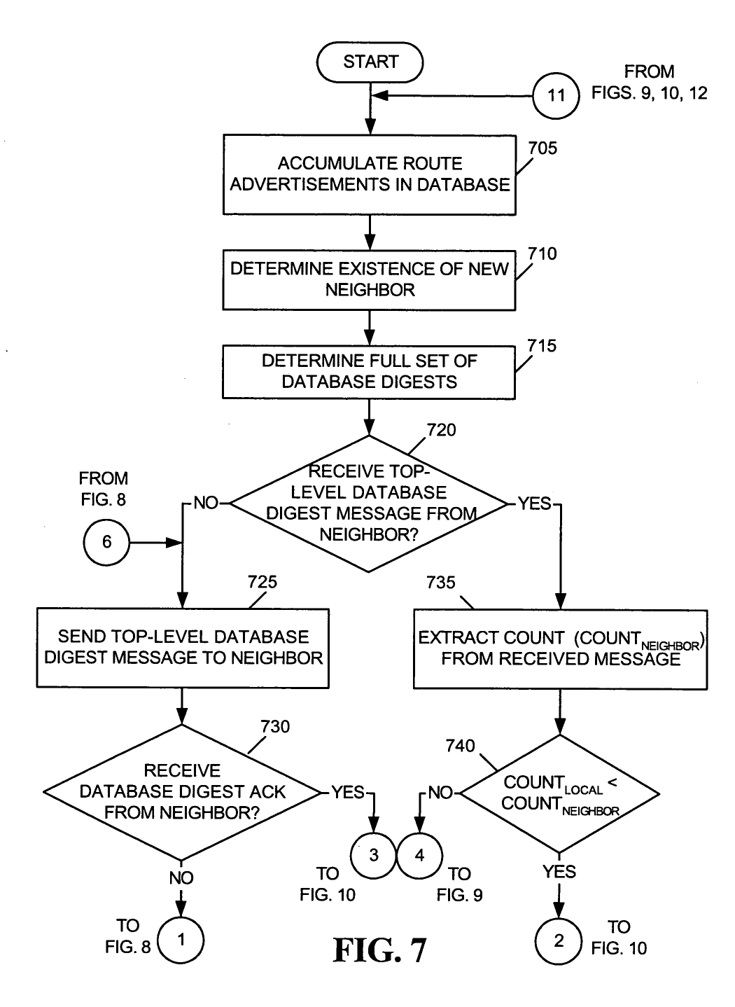

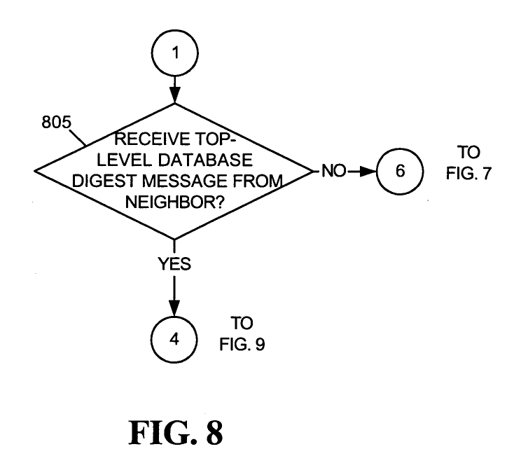

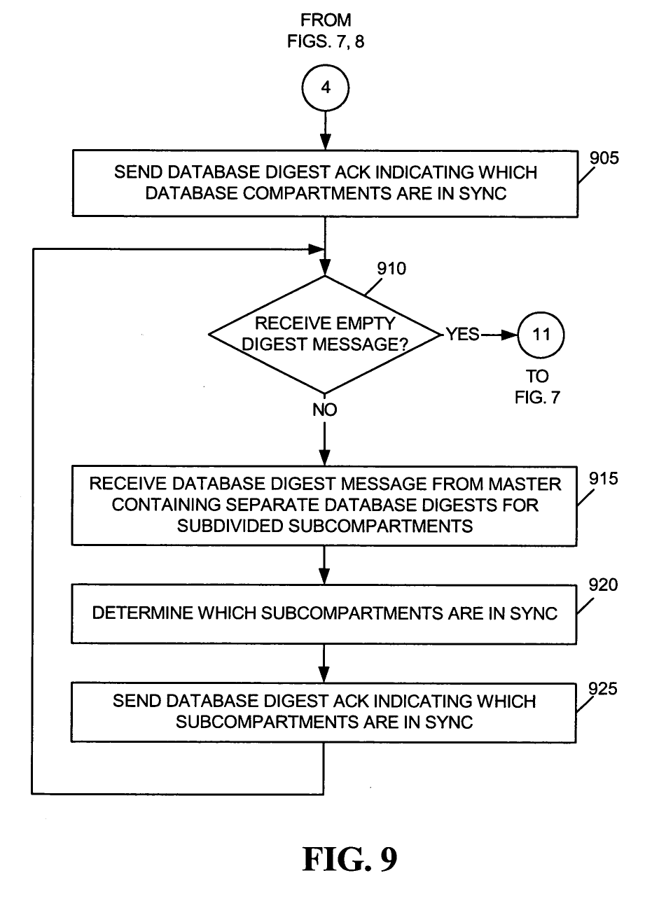

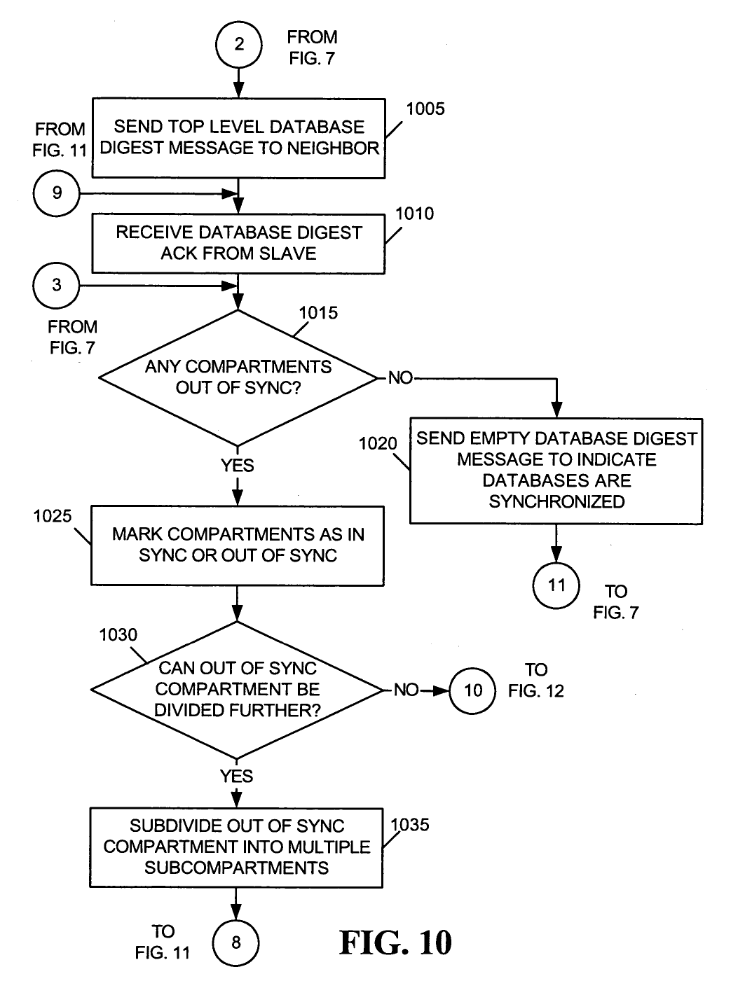

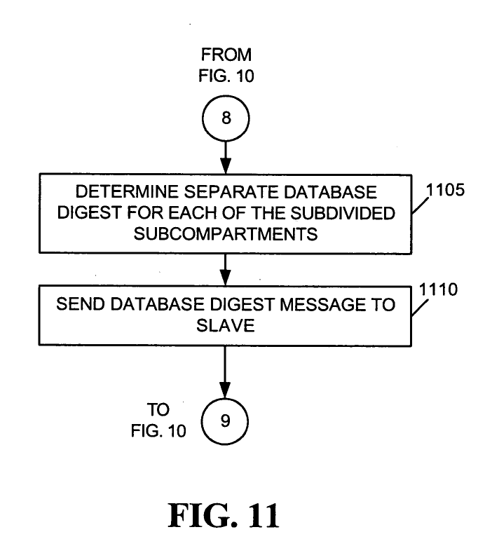

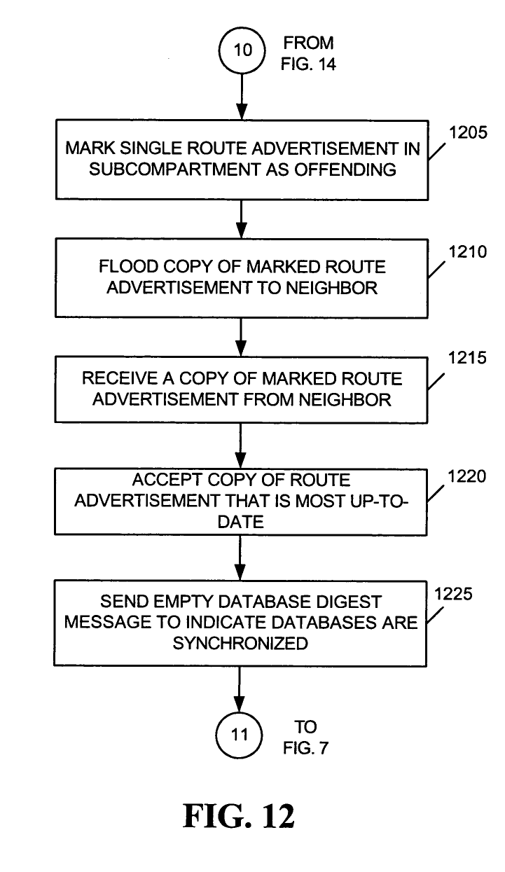

FIGS. 6A and 6B illustrate an exemplary database digest messaging sequence consistent with the principles of the invention. The message sequence of FIGS. 6A and 6B illustrates a somewhat simplified version of a process, described in more detail below with respect to FIGS. 7-12, by which databases in two different routers 110 are synchronized using database digests. As shown in FIGS. 6A and 6B, the messaging sequence may include a period 610 during which “top-level database digests” are exchanged, a period 615 during which “lower level database digests” are exchanged, a period 620 during which the exchange of “database” is completed, and a period 625 during which route advertisements from out-of sync “compartments” are exchanged.

During period 610 in which “top-level database digests” are exchanged, a router 110, designated as a “master” 600 in the database digest exchange process, may determine database digests 628. The “top-level database digests” may include digests of all of the “compartments” of route advertisements 305 portion of database 300. The digests may include, for example, a checksum or a hash computed over the fields of the multiple route advertisements stored in database 300. Each digest may be used to compare the contents of the routing databases stored at two different nodes in network 100, while minimizing the amount of information that has to be exchanged. If the routing databases are identical, then the digests may be identical as well. If not, then, with very high likelihood, the two digests may be different.

Digests may be determined, consistent with one implementation of the invention, by hashing the fields of the multiple route advertisements stored in database 300. A hashing algorithm, such as, for example, the “ripemd-128” hashing algorithm may be used to uniformly distribute a domain across its range. A hash “sum” may be accumulated over all route advertisements contained within a particular compartment of route advertisements 305 of database 300. Each route advertisement may be zero extended to a multiple of 128 bits, and then divided into 128-bit pieces. The hash “sum” may be accumulated over each of these pieces. Certain fields in each route advertisement, such as a conventional “age” field may be omitted when computing the hash “sum,” by replacing the fields with all zeroes prior to computing the hash sum.

Computation of a single database digest across each route advertisement database 300 to be compared would provide a simple indication of whether or not the two databases were already equal, but nevertheless would not be particularly useful. Due to time delays in the propagation of route advertisements, it would be extremely common for the routing databases in two routers forming a new adjacency to be almost equal, but still differ in a handful of route advertisements. With only a single hash sum, there may be no quick way to identify which advertisements are out of synchronization.

“Out-of-sync” route advertisements, however, may be quickly identified by combining the digest test with a tree search. The route advertisement database may be divided into multiple compartments, based upon the OSPF route ID of the originating router (for OSPF router links and network links advertisements) or concatenation of the OSPF router ID with the advertised external network address (for OSPF AS external and summary links advertisements). A separate database digest may then be computed for each such compartment. If the digests for corresponding compartments in the two routing databases are equal, then the contents of that compartment can be assumed to be in sync between the two routers and nothing further may need to be done. If not, however, then at least one route advertisement in that compartment must differ.

To identify the out-of-sync advertisement(s), the process may be repeated. The compartment may again be subdivided into multiple subcompartments, and a separate database digest computed for each. If the digests for the corresponding subcompartments in the two routing databases are equal, then their contents can again be assumed to be in sync. If not, then at least one route advertisement in that subcompartment must differ.

The subcompartment may be divided again, and the process may continue. The process may terminate when a subcompartment cannot be subdivided further, because it only contains one route advertisement. This single route advertisement must, therefore, be the offending advertisement. Alternatively, the process may terminate when further subdivision would no longer be particularly useful, for example, if the size of the subcompartment is smaller than that of the database digest. In that case, it may be more efficient to treat all remaining route advertisements in the subcompartment as out-of-synchronization than to continue the process of subdividing the compartment and exchanging database digests.

When offending advertisements are randomly distributed, the tree search may have a minimum depth if all compartments are roughly the same size. This can be achieved by using a hash algorithm to define the compartments. In order to minimize the number of messages that will need to be exchanged between routers in the course of the tree search, the number of subdivisions used at each step should be just large enough that their database digests fill a reasonably sized message. This may include a configurable parameter, num-digest-subcompartments-per-compartment. If num-digest-subcompartments-per-compartment is restricted to be a power of 2, then a hash function may be appropriately defined. Denote a tree level as L, starting with L=0 as the root, so that the first division of the routing database corresponds to L=1. Also denote 32/[log 2 (num-digest-subcompartments-per-compartment)] by s (for skip). Then at each level, a hash value may be constructed by concatenating bits L-1, L-1+s, L-1+2s, . . . etc. The result may be a value between 0 and num-digest-subcompartments-per-compartment-1. Each route advertisement may be assigned to a compartment corresponding to the computed hash value.

Master 600 may then send a database digest message 630 to a router 110 designated as a “slave” 605. Message 630 may correspond to the format of message 400 and may include a full set of digests for each of the compartments of the route advertisement database 300. Slave 605 may determine database digests 632 of its own route advertisement database 300 in response to receipt of message 630 from master 600. Slave 605 may then return a database digest ACK message 634 to master 600 indicating which compartments, identified in message 630, are out-of-sync.

During period 615 during which lower level database digests are exchanged, master 600 may proceed to a next lower layer in the tree. At this next lower layer, master 600 may determine out-of-sync compartment(s) 636 and decompose those out-of-sync compartments, sending one or more database digest messages 638, 640 and 642 for the subcompartments of the out-of-sync compartments to slave 605. For each database digest message received, slave 605 may return a database digest ACK message 644 and 648, with each ACK message indicating which sub-compartments are in-sync or out-of-sync.

During period 620 during which the exchange of database digests is completed, master 600 may determine which compartments are out-of-sync 650. If there are no compartments/sub-compartments that are out-of-sync, then master 600 may send an empty database digest message 652 to slave 605. The empty database digest message 652 may indicate that the offending route advertisement, that is out-of-sync between master 600 and slave 605, has been determined. Slave 605 may respond by returning a database digest ACK message 654 to master 600.

During period 625 during which route advertisements from out-of-sync compartments are exchanged between master 600 and slave 605, master 600 may send one or more route advertisements 656 and 658 from an out-of-sync compartment to slave 605. The one or more route advertisements 656 and 658 are the offending advertisements determined in the digest exchange process describe above. Slave 605 may also send corresponding ones of the one or more route advertisements 660 and 662 to master 600.

### EXEMPLARY DATABASE SYNCHRONIZATION PROCESS

FIGS. 7-12 are flow charts that illustrate an exemplary process, consistent with principles of the invention, for synchronizing databases between two nodes in network 100 using database digests. As one skilled in the art will appreciate, the exemplary process of FIGS. 7-12 can be implemented in logic, such as, for example, combinational logic, within each router 110 of network 100. Alternatively, the exemplary process of FIGS. 7-12 can be implemented in software and stored on a computer-readable memory, such as Random Access Memory (RAM) or Read Only Memory (ROM), associated with each router 110 of network 100. Alternatively, the exemplary process of FIGS. 7-12 may be implemented in any combination of software or hardware. Though the exemplary process of FIGS. 7-12 is illustrated as an iterative loop, the exemplary process may be stopped, in some implementations, upon system power-down, by way of user control, etc.

The exemplary process may begin with the accumulation of route advertisements in database 300 from other routers 110 in network 100 [act 705]. Such route advertisements may include conventional OSPF advertisements, such as, for example, router links advertisements, network links advertisements, AS-external advertisements and summary link advertisements. A determination of the existence of a new neighbor may be made by receipt of HELLO messages from the neighbor, or by notification from the link layer or a lower network layer using mechanisms provided by that link layer or lower network layer [act 710]. A full set of database digests may then be determined [act 715]. As described above, the full set of top-level database digests, may include digests of all of the top-level “compartments” of the route advertisements 305 portion of database 300. The digests may include, for example, a checksum or a hash computed over the fields of the multiple route advertisements stored in database 300.

A determination may then be made whether a top-level database digest message has been received from the new neighbor [act 720]. If not, then a top-level database digest message may be sent to the new neighbor [act 725]. The top-level database digest may include the full set of database digests determined in act 715 above. A determination may then be made whether a database digest acknowledgment (ACK) has been received from the new neighbor in response to the sent database digest message [act 730]. If so, then the exemplary process may continue at act 1015 below (FIG. 10). If a database digest ACK has not been received from the new neighbor, then a determination may be made whether a top-level database digest message has been received from the new neighbor [act 805](FIG. 8). If not, then the exemplary process may return to act 725 (FIG. 7) above.

If a top-level database digest message has been received from the new neighbor, then a database digest ACK, indicating which database compartments are in sync, may be sent to the new neighbor [act 905]. To determine which database compartments are in-sync, each compartment digest retrieved from the received top-level database digest may be compared with a corresponding locally determined digest. If the locally determined digest, and the retrieved compartment digest, are not the same, then the corresponding compartment of the routing database may be considered out-of-sync.

A determination may then be made whether an empty database digest message has been received from the new neighbor [act 910]. If so, then the exemplary process may return to act 705 above (FIG. 7). If not, then a database digest message may be received from the new neighbor (i.e., the “master”) containing separate database digests for subdivided sub-compartments [act 915]. A determination may be made as to which of the sub-compartments are in-sync [act 920]. To determine which database sub-compartments are in-sync, each sub-compartment digest retrieved from the received database digest message may be compared with a corresponding locally determined digest. If the locally determined digest, and the retrieved sib-compartment digest, are not the same, then the corresponding sub-compartment of the routing database may be considered out-of-sync. A database digest ACK may be sent to the new neighbor (i.e., the “master”) indicating which sub-compartments are in sync [act 925]. The exemplary process may then return to act 910 above.

Returning to act 720, if a top-level database digest message is received from the new neighbor, then a count (COUNT_{neighbor}) (e.g., from “compartments remaining” field 445) may be extracted from the received message [act 725]. The count (COUNT_{neighbor}) may be compared with a locally determined count (COUNT_{local}) to determine whether COUNT_{local} is less than COUNT_{neighbor}[act 720]. COUNT_{neighbor} may indicate how many database digest messages would be needed by the neighboring node to describe its routing database. Similarly, COUNT_{local} may indicate how many database digest messages that the local node would have to send to the neighboring node to describe its own routing database. If COUNT_{local} is not less than COUNT_{neighbor} then the exemplary process may continue at act 905 (FIG. 9) described above. If COUNT_{local} is less than COUNT_{neighbor} then a top-level database digest message may sent to the new neighbor [act 1005](FIG. 10). A database digest ACK message may then be received from the new neighbor (i.e., the “slave”) (act 1010). A determination may then be made whether any compartments are out-of-sync [act 1015]. To determine which database compartments are in-sync, each compartment digest retrieved from the received database digest message may be compared with a corresponding locally determined digest. If the locally determined digest, and the retrieved compartment digest, are not the same, then the corresponding compartment of the routing database may be considered out-of-sync. If none of the compartments are out-of-sync, then an empty database digest message may be sent to the new neighbor to indicate that the new neighbor's, and the current router's, databases are synchronized [act 1020]. The exemplary process may then return to act 705 above. If any of the compartments are out-of-sync, then each of the compartments may be marked in indicators 310 of database 300 as being either in-sync, or out-of-sync [act 1025].

A determination may be made whether each of the out-of-sync compartments may be divided further [act 1030]. An out-of-sync compartment may be divided further if the division would result in at least a single route advertisement remaining in the subdivided compartment. If each of the out-of-sync compartments may be divided further, then each of the out-of-sync compartments may be subdivided into multiple sub-compartments [act 1035]. A separate database digest for each of the subdivided sub-compartments may be determined [act 1105]. A database digest message may then be sent to the new neighbor (i.e., the “slave”) [act 1110]. The exemplary process may then return to act 1010 (FIG. 10) above.

Returning to act 1030, if any of the out of sync compartments cannot be subdivided further, then a single route advertisement, corresponding to each of the out of sync compartments that cannot be subdivided further, may be marked as an “out-of-sync” route advertisement [act 1205] (FIG. 12). A local copy of the marked route advertisement may be flooded to the new neighbor [act 1210]. A copy of the marked route advertisement may also be received from the new neighbor [act 1215]. The copy (i.e., local or neighbor) of the route advertisement that is most up-to-date may be accepted as the route advertisement to be used for routing purposes [act 1220]. An empty database digest message may be sent to the new neighbor to indicate that the local route advertisement database, and the neighbor's route advertisement database, are synchronized [act 1225]. The exemplary process may then return to act 705 (FIG. 7).

### Conclusion

Systems and methods consistent with principles of invention implement a routing database synchronization process that uses database digests, such as, for example, a hash or a checksum, for comparing the respective contents of databases stored at different nodes in a network. A hash or checksum computed over portions of the databases may be exchanged between the nodes in the network to permit comparisons of the resulting “digests.” The results of the comparisons may be used to determine specific data (e.g., route advertisements) within each of the routing databases that are “out of sync,” and which, therefore, may then be exchanged between the nodes to ensure that each node has an identical copy of the data.

The foregoing description of preferred embodiments of the present invention provides illustration and description, but is not intended to be exhaustive or to limit the invention to the precise form disclosed. Modifications and variations are possible in light of the above teachings or may be acquired from practice of the invention. For example, while this invention is described herein in terms of its applicability to a packet radio network, it will be appreciated, that the actual physical means of communication employed by that network may vary. It may include wired, radio, sonar, optical, microwave, and other physical forms of communication. Some aspects of the invention may include variants and future derivatives of OSPF, other link-state routing protocols, hybrids, and variants thereof, which may form components of the Ipv4 protocol suite, the Ipv6 protocol suite, the OSI protocol suite, other networking suites, or may stand independently.

Likewise, while the invention has been described herein with regards to the synchronization of databases containing routing information, and in particular databases containing OSPF routing information, it will be apparent, that the invention does not actually depend upon the content of the database. The same method could be applied to the routing database employed by any routing protocol that requires or can benefit from database synchronization. To do so, one would substitute that protocol's router ID or router address for the OSPF router ID used as the key for subdividing the routing database into compartments, and employ packet formats suitable to that routing protocol. Similarly, the same method could be applied to a database containing multicast group membership information, again employing the originating router's address or ID as the key for subdivision into compartments. Furthermore, the same method could be applied to any type of distributed database whose contents had to be kept synchronized, as long as its contents are amenable to subdivision into compartments as previously described and the contents of each compartment are amenable to summarization by means of a “database digest”.

Likewise, while the exchange of database description messages has been described herein using a master/slave model, other methods could be employed for affecting this exchange. For instance, one could employ a windowing model using sequence numbers, or an alternating master/slave model in which the two adjacent nodes switch between the role of master and slave on each exchange. The precise method of exchange and sequence of messages is inconsequential to the invention, except that the exchange of database digests describing a particular compartment must be performed before the exchange of database digests for any of its sub-compartments.

Also, while the synchronization of databases has described herein as between databases located on neighboring routers in a network, the same method could be applied to the synchronization of databases in other contexts as well. For instance, the databases could be located on routers that are not immediately adjacent, with synchronization to be performed any time connectivity were established between those routers. One, more, or all of the databases could be located on a host, instead of a router, with synchronization to be performed any time connectivity were established between the platforms on which those databases were located. Alternatively, one or more of the databases could co-exist on the same platform, with synchronization to be performed when required by the application.

While series of acts have been described with regard to FIGS. 7-12, the order of the acts may be modified in other implementations consistent with the principles of the invention. Also, non-dependent acts may be performed in parallel. No element, act, or instruction used in the description of the present application should be construed as critical or essential to the invention unless explicitly described as such. Also, as used herein, the article “a” is intended to include one or more items. Where only one item is intended, the term “one” or similar language is used.

The scope of the invention is defined by the following claims and their equivalents.

What is claimed is:

1. A method of synchronizing routing data with another node in a network, comprising:
receiving routing data;
performing a function on at least a portion of the routing data to produce a first digest, where the first digest comprises substantially less data than the routing data;
receiving a second digest from the other node;
comparing the first and second digests to determine whether they are identical to produce first comparison results; and
exchanging a portion of the routing data based on the first comparison results.

2. The method of claim 1, wherein the function comprises at least one of a checksum or a hash.

3. The method of claim 1, wherein the other node performs the function on a corresponding at least a portion of the routing data stored at the other node to produce the second digest.

4. The method of claim 1, wherein the routing data comprises Open Shortest Path First (OSPF) route advertisements.

5. The method of claim 1, further comprising:
receiving multiple third digests from the other node, where the multiple third digests identify multiple sub-portions of the routing data stored at the other node.

6. The method of claim 5, further comprising:
performing the function on corresponding sub-portions of the routing data that is locally stored to produce multiple local digests.

7. The method of claim 6, further comprising:
comparing the multiple local digests with the multiple third digests to produce second comparison results; and
exchanging further portions of the routing data based on the second comparison results.

8. A first node in a network, comprising:
a plurality of interfaces configured to:
receive routing data, and
receive a first digest from a second node in the network; and
processing logic configured to:
perform a function on at least a portion of the routing data to produce a second digest, where the second digest comprises substantially less data than the routing data,
compare the first and second digests to determine whether they are identical to produce first comparison results,
where the plurality of interfaces are further configured to exchange a portion of the routing data based on the first comparison results.

9. A computer-readable medium containing instructions for controlling a processor to perform a method of synchronizing routing data with another node in a network, the method comprising:
receiving routing data;
performing a function on at least a portion of the routing data to produce a first digest, where the first digest comprises substantially less data than the routing data and where the function comprises at least one of a checksum or a hash;
receiving a second digest from the other node;
comparing the first and second digests to determine whether they are identical to produce first comparison results; and
exchanging one or more portions of the routing data based on the first comparison results.

10. A method for designating nodes as one of a master node or a slave node for synchronizing routing data in a network, comprising:
subdividing routing data stored at a first node into multiple portions;
counting the number of multiple portions to produce a first count;
receiving a first message from a second node at the first node, the first message comprising a second count associated with a number of subdivided portions of the second node's routing data;
comparing the first count with the second count to produce first comparison results;
designating the second node as a slave node based on the first comparison results; and
sending a second message to the second node if the second node is designated as a slave node, where the second message comprises a digest associated with the routing data stored at the first node.

11. The method of claim 10, wherein the first message further comprises a digest associated with routing data stored at the second node.

12. The method of claim 10, further comprising:
performing a function to produce the digest, where the digest produced by the function has substantially less data than the routing data stored at the first node.

13. The method of claim 12, wherein the function comprises at least one of a hash or a checksum.

14. The method of claim 10, further comprising:
designating the first node as a master node based on the first comparison results.

15. The method of claim 12, further comprising:
subdividing each of the multiple portions into multiple sub-portions;
performing the function on each of the multiple sub-portions to produce multiple digests.

16. The method of claim 15, further comprising:
sending a third message to the second node, where the third message comprises the multiple digests.

17. A first node in a network, comprising:
a memory;
an interface configured to:
receive routing data,
store the routing data in the memory, and
receive a first message from a second node, the first message comprising a first count associated with a number of subdivided portions of the second node's routing data;
processing logic configured to:
subdivide routing data stored in the memory into multiple portions,
count the number of multiple portions to produce a second count,
compare the second count with the first count to produce first comparison results,
designate the second node as a slave node based on the first comparison comparison results;
wherein the interface is further configured to:
send a second message to the second node if the second node is designated a slave node, wherein the second message comprises a digest associated with the routing data stored in the memory.

18. A method of using database digests to synchronize routing data between a first node and a second node in a network, comprising:
storing first routing data at the first node;
storing second routing data at the second node;
performing, at the first node, a function on a portion of the first routing data, where the function produces a database digest that has substantially less data than the portion of the first routing data; and
sending the database digest to the second node to synchronize the first routing data with the second routing data.

19. The method of claim 18, wherein the function comprises at least one of a hash or a checksum.

20. The method of claim 18, further comprising:
receiving a first acknowledgment message from the first node based on the database digest, where the acknowledgment message indicates whether the second routing data is synchronized with the first routing data.

21. The method of claim 20, further comprising:
subdividing the portion of the first routing data into multiple subportions; and
performing the function on each of the multiple sub-portions to produce multiple database digests.

22. The method of claim 21, further comprising:
sending the multiple database digests to the second node to synchronize the first routing data with the second routing data.

23. The method of claim 22, further comprising:
receiving a second acknowledgment message from the second node based on the multiple database digests, where the second acknowledgment message indicates whether the multiple sub-portions are synchronized with corresponding sub-portions of the second routing data.

24. A system for using database digests to synchronize routing data in a network, comprising:
a first node configured to store first routing data;
a second node configured to:
store second routing data,
perform a function on a portion of the second routing data, where the function produces a database digest that has substantially less data than the portion of the second routing data, and
send the database digest to the first node to synchronize the second routing data with the first routing data.

25. A data structure encoded on a computer-readable medium, comprising:
first data comprising routing data;
second data comprising an identifier for a node in a network;
third data identifying a portion of the routing data; and
fourth data comprising a first digest of the portion of the routing data, where a function is used to produce the digest and where the digest comprises substantially less data than the portion of the routing data.

26. The data structure of claim 25, wherein the function comprises at least one of a hash or a checksum.

27. The data structure of claim 25, further comprising:
fifth data identifying another portion of the routing data; and
sixth data comprising a second digest of the other portion of the routing data, where the function is used to produce the second digest and where the second digest comprises substantially less data than the other portion of the routing data.

28. A system for using database digests to synchronize routing data between a first node and a second node in a network, comprising:
means for storing first routing data at the first node;
means for storing second routing data at the second node;
means for performing, at the first node, a function on one or more portions of the first routing data, where the function produces a database digest that has substantially less data then a respective one of the one or more portions of the first routing data; and
means sending the database digest to the second node to synchronize the first routing data with the second routing data.

29. A method of synchronizing data with another node in a network, comprising:
performing a function on at least a portion of the data to produce a first digest, where the first digest comprises substantially less data than the at least a portion of the data;
receiving a second digest from the other node;
comparing the first and second digests to determine whether they are identical to produce first comparison results; and
exchanging a portion of the data based on the first comparison results.

30. The method of claim 29, wherein the function comprises at least one of a checksum or a hash.

31. The method of claim 29, wherein the other node performs the function on a corresponding at least a portion of the data stored at the other node to produce the second digest.

32. The method of claim 29, wherein the data comprises Open Shortest Path First (OSPF) route advertisements.

33. The method of claim 29, further comprising:
receiving multiple third digests from the other node, where the multiple third digests identify multiple sub-portions of the data stored at the other node.

34. The method of claim 33, further comprising:
performing the function on corresponding sub-portions of the data that is locally stored to produce multiple local digests.

35. The method of claim 34, further comprising:
comparing the multiple local digests with the multiple third digests to produce second comparison results; and
exchanging further portions of the data based on the second comparison results.

36. A method of using database digests to synchronize data between a first node and a second node in a network, comprising:
storing first data at the first node;
storing second data at the second node;
performing, at the first node, a function on a portion of the first data, where the function produces a database digest that has substantially less data than the portion of the first data; and
sending the database digest to the second node to synchronize the first data with the second data.

37. The method of claim 36, wherein the function comprises at least one of a hash or a checksum.

38. The method of claim 36, further comprising:
receiving a first acknowledgment message from the first node based on the database digest, where the acknowledgment message indicates whether the second data is synchronized with the first data.

39. The method of claim 38, further comprising:
subdividing the portion of the first data into multiple subportions; and
performing the function on each of the multiple sub-portions to produce multiple database digests.

40. The method of claim 39, further comprising:
sending the multiple database digests to the second node to synchronize the first data with the second data.

41. The method of claim 40, further comprising:
receiving a second acknowledgment message from the second node based on the multiple database digests, where the second acknowledgment message indicates whether the multiple sub-portions are synchronized with corresponding sub-portions of the second data.
